(19) United States
(12) Patent Application Publication
(10) Pub. No.: US 2025/0254661 A1
(43) Pub. Date: Aug. 7, 2025

(54) COMMUNICATION APPARATUSES AND COMMUNICATION METHODS FOR UTILISATION OF SL-RSRP IN V2X RESOURCE SENSING AND SELECTION

(71) Applicant: Panasonic Intellectual Property Corporation of America, Torrance, CA (US)

(72) Inventors: Yang KANG, Singapore (SG); Hidetoshi SUZUKI, Kanagawa (JP); Naoya SHIBAIKE, Kanagawa (JP)

(21) Appl. No.: 19/186,424

(22) Filed: Apr. 22, 2025

Related U.S. Application Data
(63) Continuation of application No. 17/764,496, filed on Mar. 28, 2022, now Pat. No. 12,309,749.

(30) Foreign Application Priority Data
Oct. 4, 2019 (SG) 10201909315Q

(51) Int. Cl. H04W 72/02

(52) U.S. Cl. CPC H04W 72/02

(57) ABSTRACT

The present disclosure provides communication apparatuses and communication methods for utilization of SL-RSRP in V2X resource sensing and selection. The communication apparatuses include a communication apparatus comprising: circuitry which, in operation, adjusts a parameter based on at least one of a plurality of priority levels, and determines a plurality of resource candidates based on the adjusted parameter; and a transmitter which, in operation, transmits a transmission block (TB) using a resource selected from the plurality of resource candidates.

### TECHNICAL FIELD

The following disclosure relates to communication apparatuses and communication methods for New Radio (NR) communications, and more particularly to communication apparatuses and communication methods for utilisation of SL-RSRP in V2X resource sensing & selection.

### BACKGROUND

V2X communication allows vehicles to interact with public roads and other road users, and is thus considered a critical factor in making autonomous vehicles a reality.

To accelerate this process, 5G NR based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink (S L) with other nearby vehicles, infrastructure nodes and/or pedestrians. The status information includes information on position, speed, heading, etc.

In such V2X communications, there are at least two SL resource allocation modes being discussed by the 3GPP. In resource allocation Mode 1, SL resource(s) to be used by a UE for SL transmissions are scheduled by a base station (BS). In resource allocation Mode 2, the UE determines, i.e. the BS does not schedule, SL transmission resources within the SL resources configured by the BS/network or pre-configured SL resources. The 3GPP study on resource allocation also considers sensing and resource selection procedures for a Mode 2(a), in the context of a semi-persistent scheme where resource(s) are selected for multiple transmissions of different transmission blocks (TBs) and a dynamic scheme where resource(s) are selected for each TB transmission.

In the 3GPP RAN WG1 #98 meeting in Prague, the following items were considered:
The resource (re-)selection procedure includes the following steps:
   Step 1: Identification of candidate resources within the resource selection window (FFS details).
   Step 2: Resource selection for (re-)transmission(s) from the identified candidate resources (FFS details).
In Step 1 of the resource (re-)selection procedure, a resource is not considered as a candidate resource if:
   The resource is indicated in a received SCI and the associated Li Sidelink Reference Signal Received Power (SL-RSRP) measurement is above an SL-RSRP threshold.
   The SL-RSRP threshold is at least a function of the priority of the S L transmission indicated in the received SCI and the priority of the transmission for which resources are being selected by the UE.
   FFS details.

However, there has been no discussion on communication apparatuses and methods for utilization of SL-RSRP in V2X resource sensing & selection.

There is thus a need for communication apparatuses and methods that provide feasible technical solutions for utilization of SL-RSRP in V2X resource sensing & selection. Furthermore, other desirable features and characteristics will become apparent from the subsequent detailed description and the appended claims, taken in conjunction with the accompanying drawings and this background of the disclosure.

### SUMMARY

Non-limiting and exemplary embodiment facilitates providing communication apparatuses and methods for utilisation of SL-RSRP in V2X resource sensing & selection.

According to a first embodiment of the present disclosure, there is provided a communication apparatus comprising: circuitry which, in operation, adjusts a parameter based on at least one of a plurality of priority levels, and determines a plurality of resource candidates based on the adjusted parameter; and a transmitter which, in operation, transmits a transmission block (TB) using a resource selected from the plurality of resource candidates.

According to a second embodiment of the present disclosure, there is provided a communication method comprising: adjusting a parameter based on at least one of a plurality of priority levels; determining a plurality of resource candidates based on the adjusted parameter; and transmitting a transmission block (TB) using a resource selected from the plurality of resource candidates.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for RRC connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 depicts a schematic diagram 600 illustrating a V2X resource sensing & selection process according to various embodiments.

FIG. 7 shows a flow diagram 700 illustrating how a physical (PHY) layer performs sensing according to various embodiments.

FIG. 8 shows a flow diagram 800 illustrating how SL-RSRP is utilised in V2X resource sensing & selection according to an embodiment.

FIG. 9 shows a flow diagram 900 illustrating how SL-RSRP is utilised in V2X resource sensing & selection according to another embodiment.

FIG. 10 shows a flow diagram 1000 illustrating how SL-RSRP is utilised in V2X resource sensing & selection according to yet another embodiment.

FIG. 11 shows a flow diagram 1100 illustrating a communication method according to various embodiments.

FIG. 12 shows a schematic example of communication apparatus in accordance with various embodiments. The communication apparatus may be implemented as an UE or a gNB/base station and configured for utilising SL-RSRP in accordance with various embodiments of the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3G PP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

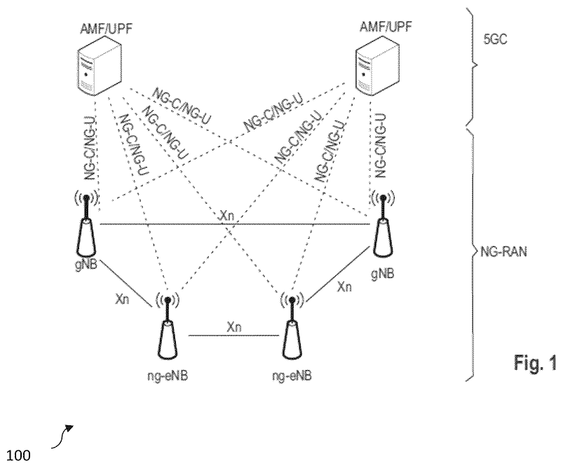

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH (Physical Uplink Shared Channel) and PUCCH (Physical Uplink Control Channel) for uplink and PDSCH (Physical Downlink Shared Channel), PDCCH (Physical Downlink Control Channel) and PBCH (Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OF DM/SC-FDMA symbol.

In the new radio system 5G-NR foreach numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

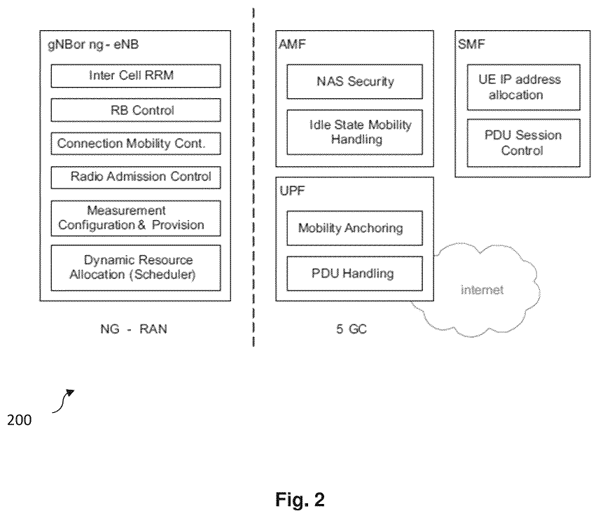

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UE s in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

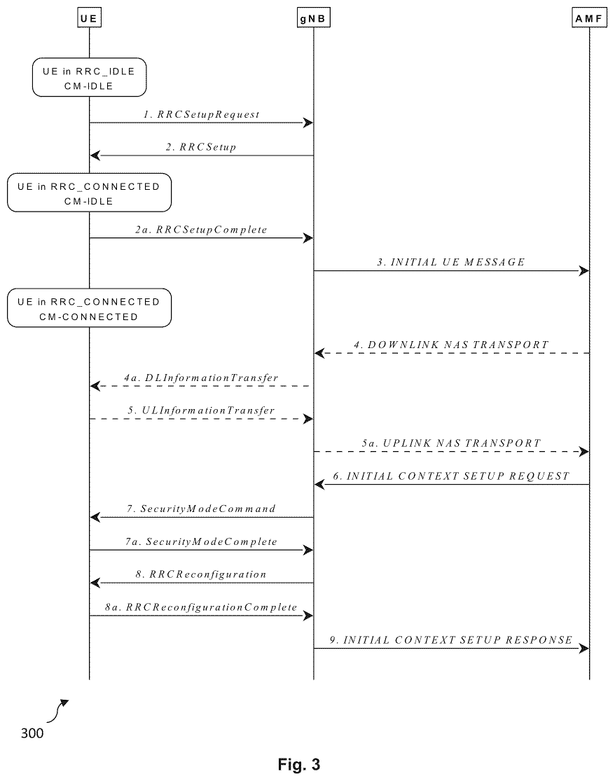

FIG. 3 illustrates some interactions between a UE, gNB, and AMF (an 5GC entity) in the context of a transition of the UE from RRC_IDLE to RRC_CONNECTED for the NAS part (see TS 38.300 v15.7.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 [22].
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AM F prepares the U E context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

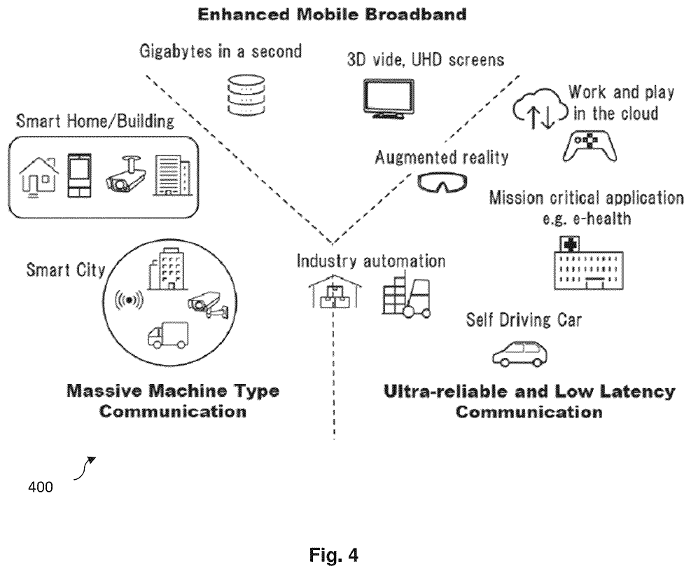

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for MT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smartgrid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E−5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for N R URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E−5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have powersaving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

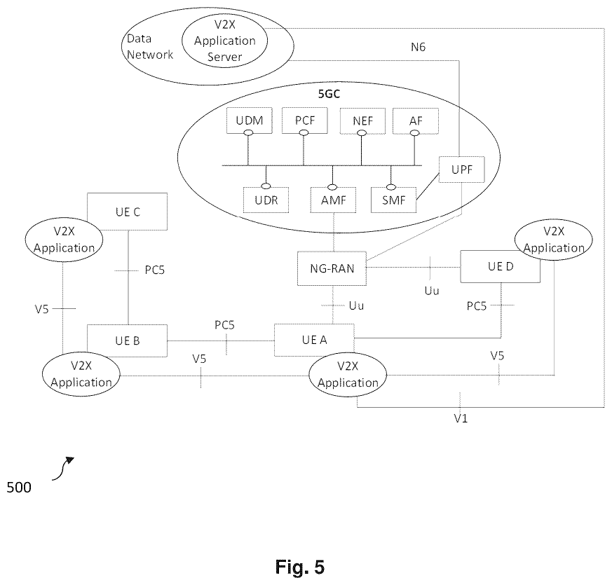

FIG. 5 illustrates a 5G NR non-roaming reference architecture (see TS 23.287 v16.0.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of UR LLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

In the present disclosure, an application server (for example, V2X Application Server in FIG. 5) may be provided to handle QoS requirements for V2X communications as per defined in Section 5.4 of TS23.287.

PHY layer sensing and reporting of resources in LTE V2X are defined in the TS36.213 section 14.1.1.6 as per the following steps:
1) A candidate single-subframe resource for PSSCH transmission R_{x,y} is defined as a set of L_{subCH} contiguous sub-channels with sub-channel x+j in subframe t_{y}^{SL} where j=0, . . . , L_{subCH}−1. The UE shall assume that any set of L_{subCH} contiguous sub-channels included in the corresponding PSSCH resource pool (described in 14.1.5) within the time interval [n+T₁,n+T₂] corresponds to one candidate single-subframe resource, where selections of T₁ and T₂ are up to UE implementations under T₁<4 and TTX₂_{₂ₘᵢₙ}f TTX₂ₘᵢₙ provided by higher layers for prio_{TX}, otherwise 20≤T₂≤100. UE selection of T₂ shall fulfil the latency requirement. The total number of the candidate single-subframe resources is denoted by Mₜₒₜₐₗ.
2) The UE shall monitor subframes t_{n′-10×P}_{ₛₜₑₚ}^{SL}, t_{n′-10×P}_{ₛₜₑₚ}₊₁^{SL}, . . . , t_{n′-1}^{SL} except for those in which its transmissions occur, where t_{n′}^{SL}=n if subframe n belongs to the set (t₀^{SL}, t₁^{SL}, . . . , t_{T}_{ₘₐₓ}^{SL}( )) otherwise subframe t_{n′}^{SL} is the first subframe after subframe n belonging to the set (t₀^{SL}, t₁^{SL}, . . . , t_{T}_{ₘₐₓ}^{SL}( )) he UE shall perform the behaviour in the following steps based on PSCCH decoded and S-RSSI measured in these subframes.
3) The parameter Th_{a,b} is set to the value indicated by the i-th SL-ThresPSSCH-RSRP field in SL-ThresPSSCH-RSRP-List where i=a*8+b+1.
4) The set S_{A} is initialized to the union of all the candidate single-subframe resources. The set S_{B} is initialized to an empty set.
5) The UE shall exclude any candidate single-subframe resource R_{x,y} from the set S_{A} if it meets all the following conditions:
   the UE has not monitored subframe t_{z}^{SL} in Step 2.
   there is an integer j which meets y+j×Pᵣₛᵥₚ_{_{TX}}′=z+Pₛₜₑₚ×k×q where j=0, 1, . . . , Cᵣₑₛₑₗ−1,

$${P}_{{rsvp}_{TX}}^{′} = {P}_{step} \times \frac{{P}_{{rsvp}_{TX}}}{100} ,$$

k is any value allowed by the higher layer parameter restrict Resource Reservation Period and q=1, 2, . . . , Q. Here, Q=1/k if k<1 and n′−z≤Pₛₜₑₚ×k, where t_{n′}^{SL}=n if subframe n belongs to the set t₀^{SL}, t₁^{SL}, . . . , t_{T}_{ₘₐₓ}^{SL} therwise subframe t_{n′}^{SL} is the first subframe belonging to the set t₀^{SL}, t₁^{SL}, . . . , t_{T}_{ₘₐₓ}^{SL} subframe n; and Q=1 otherwise.
6) The UE shall exclude any candidate single-subframe resource R_{x,y} from the set S_{A} if it meets all the following conditions:
   the UE receives an SCI format 1 in subframe tₘ^{SL}, and “Resource reservation” field and “Priority” field in the received SCI format 1 indicate the values P_{rsvp_RX} and prio_{Rx}, respectively according to Subclause 14.2.1.
   PSSCH-RSRP measurement according to the received SCI format 1 is higher than Thₚᵣᵢₒ_{_{TX}}_{,prio}_{_{RX′}}
   the SCI format received in subframe tₘ^{SL} or the same SCI format 1 which is assumed to be received in subframe(s)

$${t}_{m + q \times {P}_{s t e p} \times {P}_{{rsvp}_{R X}}}^{S L}$$

determines according to 14.1.1.4C the set of resource blocks and subframes which overlaps with

$${R}_{x , y + j \times {P}_{{rsvp}_{T X}}^{′}}$$

for q=1, 2, . . . , Q and j=0, 1, . . . , Cᵣₑₛₑₗ−1. Here,

$$Q = \frac{1}{{P}_{{rsvp}_{RX}}}$$

if Pᵣₛᵥₚ_{_{RX}}<1 and n′−m≤Pₛₜₑₚ×Pᵣₛᵥₚ_{_{RX}}, where t_{n′}^{SL}=n if subframe n belongs to the set (t₀^{SL}, t₁^{SL}, . . . , t_{T}_{ₘₐₓ}^{SL}( )) therwise subframe t_{n′}^{SL} is the first subframe after subframe n belonging to the set (t₀^{SL}, t₁^{SL}, . . . , t_{T}_{ₘₐₓ}^{SL}( )) therwise Q=1.
7) If the number of candidate single-subframe resources remaining in the set S_{A} is smaller than 0.2·Mₜₒₜₐₗ, then Step 4 is repeated with Th_{a,b} increased by 3 dB.
8) Fora candidate single-subframe resource R_{x,y} remaining in the set S_{A}, the metric E_{x,y} is defined as the linear average of S-RSSI measured in sub-channels x+k for k=0, . . . , L_{subCH}−1 in the monitored subframes in Step 2 that can be expressed by t_{y-P}_{ₛₜₑₚ}_{*j}^{SL} for a non-negative integer j if Pᵣₛᵥₚ_{_{TX}}≥100, and t_{y-P}_{_{rsvp_TX}}_{*j}_{^{′}} for a non-negative integer j otherwise.
9) The UE moves the candidate single-subframe resource R_{x,y} with the smallest metric E_{x,y} from the set S_{A} to S_{B}. This step is repeated until the number of candidate single-subframe resources in the set S_{B} becomes greater than or equal to 0.2·Mₜₒₜₐₗ,
10) When the UE is configured by upper layers to transmit using resource pools on multiple carriers, it shall exclude a candidate single-subframe resource R_{x,y} from S_{B} if the UE does not support transmission in the candidate single-subframe resource in the carrier under the assumption that transmissions take place in other carrier(s) using the already selected resources due to its limitation in the number of simultaneous transmission carriers, its limitation in the supported carrier combinations, or interruption for RF retuning time [10].
   The UE shall then report set S_{B} to higher layers.

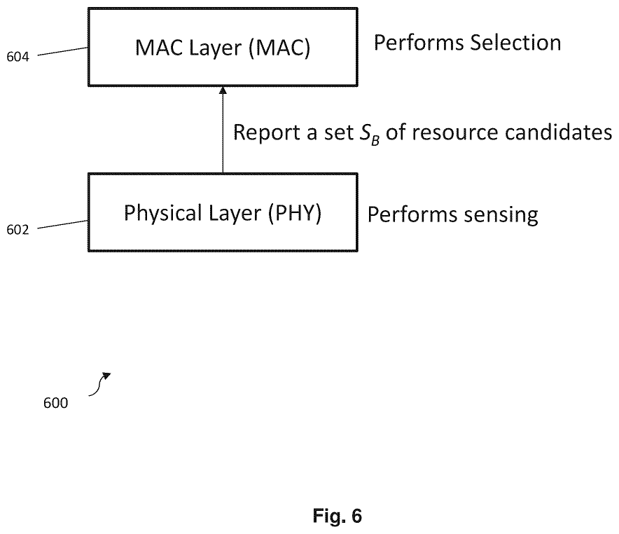

FIG. 6 depicts a schematic diagram 600 illustrating a V2X resource sensing & selection process according to various embodiments. For example, the PHY layer 602 of a UE performs sensing procedures for resource candidates from an initial set S_{A} and then reports a set of resource candidates S_{B} to the MAC layer 604 of the U E or the base station. The initial set of S_{A} contains all Mₜₒₜₐₗ candidate resources for a transmission of a TB. The PHY layer 602 may perform, during the sensing procedures, a step of resource exclusion such that the resource candidates are excluded from the initial set S_{A} until the number of resource candidates in set S_{A} is smaller than 0.2·Mₜₒₜₐₗ. The set S_{B} that is reported to the MAC layer 604 contains ≥20%*Mₜₒₜₐₗ, resource candidates with the lowest RSRP from the remaining set S_{A} after the resource exclusion step.

The UE(s) may include, for example, communication modules integrated or installed in vehicles subscribed to communication services of one or more telecommunications/Public Land Mobile Network (PLMN) operators. The UE(s) may be subscribed to a telecommunication/PLMN operator and communicates with a base station of the telecommunication operator. The base station may be a next generation NodeB (gNB). It can be appreciated by those skilled in the art that the base station can also be a ng-eNB, and may be connected via the NG interface to a 5G core network.

The SL transmission of the TB may be via a Physical Sidelink Shared Channel (PSSCH) and its corresponding control information SCI may be transmitted via a Physical Sidelink Control Channel (PSCCH).

Thus far, in LTE, the default formula/setting for the initial value of Th_{a,b} sensing procedure is common for transmission with different priorities (for example the prio_{TX}). As a result, low priority transmissions can prevent high priority transmission, especially when the channel is congested.

Therefore, the present invention proposes an improved resource (re-)selection procedure for SL transmissions with different priorities to address the above-mentioned issue, whereby procedures for identification of resource candidates are distinguished for different priorities of a transmission (prio_{TX}) by (pre-)configuration (for example, by a pre-configuration and/or by a higher layer signaling). Restrictions are independently (pre-)configured for transmissions with high priority (or belong to a high priority group) and transmissions with low priority (or belong to a low priority group) respectively. Depending on the priority of the transmission (or the priority category of the transmission), only one set of resources (S_{B}) will be reported to the higher layer.

Advantageously, transmissions with low priority do not prevent transmissions with high priority. Less crowded candidate resources (and/or more candidate resources) could be used for the sidelink transmission, especially for transmissions with higher priorities. Furthermore, less complexity is achieved if priorities are categorized into groups hence lower power consumption.

In the following paragraphs, certain exemplifying embodiments are explained with reference to a V2X communications mechanism that advantageously utilise SL-RSRP in V2X resource sensing & selection, so that the procedures for identification of resource candidates are distinguished for different priorities of the transmission.

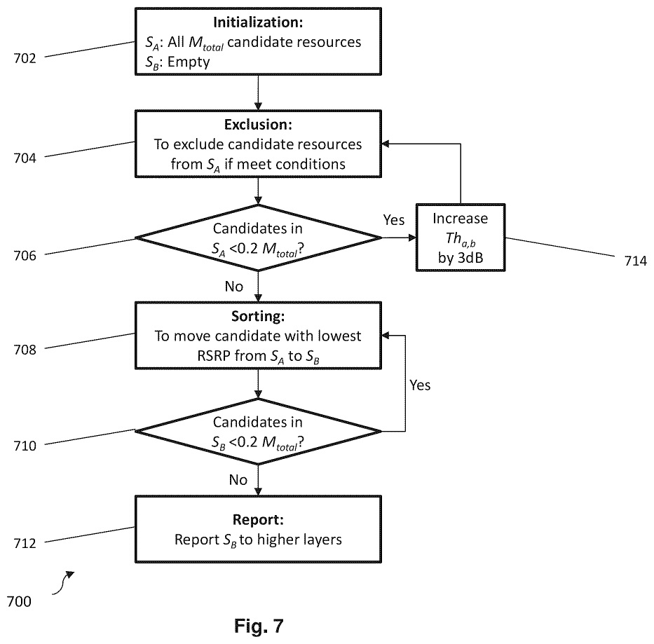

FIG. 7 shows a flow diagram 700 illustrating how a PHY layer, such as the PHY layer 602, performs sensing according to various embodiments. At step 702, the PHY layer senses a set S_{A} with all Mₜₒₜₐₗ resource candidates. At step 704, the PHY layer performs an iteration of resource exclusion such that resource candidates are excluded from set S_{A} if certain conditions are met. At step 706, it is determined whether the number of resource candidates remaining in S_{A} after the resource exclusion step 704 is <0.2 Mₜₒₜₐₗ. If it is determined that the number of resource candidates remaining in S_{A} after the resource exclusion step 704 is <0.2 Mₜₒₜₐₗ, the process proceeds to step 714 where the Th_{a,b} is increased by 3 dB, and then proceeds back to step 704 fora repeated procedure of the resource exclusion process, until it is determined at step 706 that the set S_{A} contains 20%*Mₜₒₜₐₗ resource candidates.

Thereafter, the process proceeds to a sorting step 708 where candidate resources with lowest RSRP are moved from S_{A} to S_{B}. At step 710, it is determined whether the number of resource candidates in set S_{B}<0.2 Mₜₒₜₐₗ. If it is determined that the number of resource candidates in set S_{B} is <0.2 Mₜₒₜₐₗ, the process repeats sorting step 708 until the number of resource candidates in set S_{B} is ≥0.2 Mₜₒₜₐₗ. At step 712, the set S_{B} is reported to the higher layers, for example the MAC layer 604.

In various embodiments, certain modifications may be made to the process as shown in FIG. 6 so that the procedures for identification of resource candidates are distinguished for different priorities of the transmission. For example, a parameter in the process shown in FIG. 6 may be adjusted based on at least one of a plurality of priority levels, and a plurality of resource candidates may be determined based on the adjusted parameter. A resource may then be selected from the plurality of resource candidates for transmission of a TB.

In various embodiments, the parameter may be adjusted up to a maximum value relating to the at least one of the plurality of priority levels, wherein the maximum value may be indicated by a pre-configuration or a higher layer signaling. The parameter may also be adjusted to a first maximum value relating to a first priority level or a second maximum value relating to a second priority level, wherein the first and second maximum values may be indicated by a pre-configuration or a higher layer signaling.

In various embodiments, the parameter may be increased by a (pre-)configured value up to a maximum value of the parameter when the plurality of resource candidates meets a certain condition. The (pre-)configured value may be indicated by pre-configuration or by higher layer signaling. The pre-configured value may be different among the plurality of priority levels so that the plurality of resource candidates are distinguished among the different priority levels. However, it is possible for the pre-configured value to be the same for priority levels wherein the plurality of resource candidates need not be distinguished.

In various embodiments, the at least one of the plurality of priority levels may comprise a priority level of the TB that is to be transmitted, and may be indicated by a pre-configuration and/or a control information. The plurality of priority levels may also be categorised into one or more priority groups, wherein each of the one or more priority groups comprises one or more priority levels, such that the parameter may be adjusted up to a maximum value relating to a priority group which the at least one of the plurality of priority levels is categorised. The maximum value may be different among the priority groups so that the plurality of resource candidates are distinguished among the different priority groups. However, it is possible for the maximum value to be the same for priority groups wherein the plurality of resource candidates need not be distinguished.

The Th_{a,b} may be utilised as the parameter to be adjusted. Assuming two priority levels (e.g. two prio_{TX} levels) are (pre-)configured, such as HighTx (for transmissions with high priority) and LowTx (for transmissions with low priority), an operation example would be as follows:
1. A ThTimesLowResourceForLowTx may be (pre-)configured as a maximum number where Th_{a,b} can be increased for the resource indicated by LowTx for the transmission of LowTx. A ThTimesHighAndLowResourceForHighTx may be (pre-)configured as a maximum number where Th_{a,b} can be increased for the resource indicated by HighTx or LowTx for the transmission of HighTx.
2. In the flowchart as in FIG. 6, if the remaining resource candidates in set S_{A} is less than the candidate resource ratio (e.g., 20% as in LTE) in the 1^{st} iteration of the exclusion process:
   if prio_{TX} is LowTx,
      Th_{a,b} of the resource indicated by LowTx is increased up to ThTimesLowResourceForLowTx until 20%*Mₜₒₜₐₗ remaining resource candidates are satisfied in set S_{A}
      if not, the resource is reported to the upper layer in set S_{B}
   if prio_{TX} is HighTx,
   Th_{a,b} of the resource indicated by HighTx or LowTx is increased up to ThTimesHighAndLowResourceForHighTx until 20%*Mₜₒₜₐₗ remaining candidate resources are satisfied in set S_{A}
   if not, the resource is reported to the upper layer in set S_{B}
      The rest of the operation would then be legacy as in LTE.

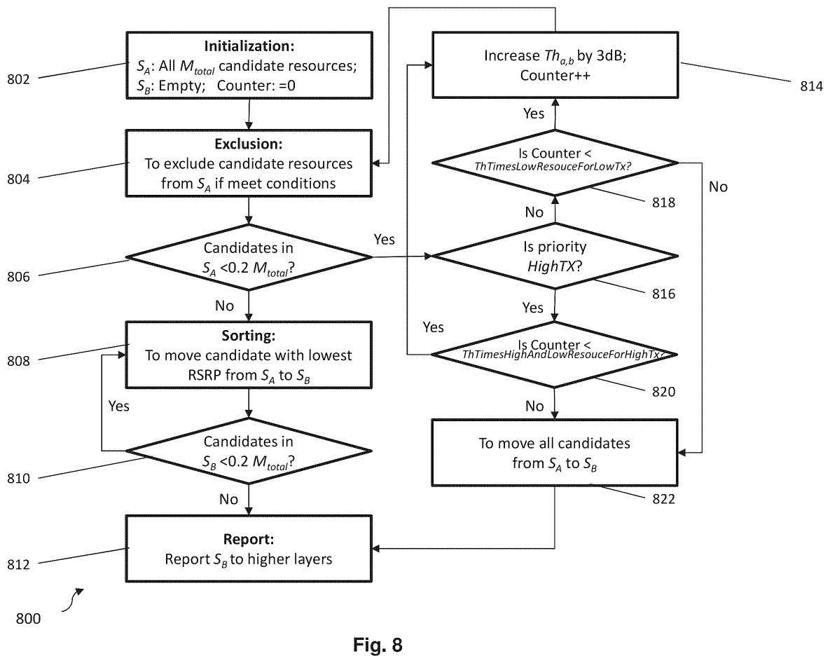

The above operation example is illustrated in the flow diagram 800 in FIG. 8. At step 802, the PHY layer, for example, the PHY layer 602, senses a set S_{A} with all Mₜₒₜₐₗ resource candidates. At step 804, the PHY layer performs an iteration of resource exclusion such that resource candidates are excluded from set S_{A} if certain conditions are met. At step 806, it is determined whether the number of resource candidates remaining in S_{A} after the resource exclusion step 804 is <0.2 Mₜₒₜₐₗ. If it is determined that the number of resource candidates remaining in S_{A} after the resource exclusion step 804 is not <0.2 Mₜₒₜₐₗ, the process proceeds to step 816, where it is determined whether the transmission priority is HighTx. Otherwise, the process proceeds to a sorting step 808 where candidate resources with lowest RSRP are moved from S_{A} to S_{B}. At step 810, it is determined whether the number of resource candidates in set S_{B}<0.2 Mₜₒₜₐₗ. If it is determined that the number of resource candidates in set S_{B} is <0.2 Mₜₒₜₐₗ, the process repeats sorting step 808 until the number of resource candidates in set S_{B} is ≥0.2 Mₜₒₜₐₗ. At step 812, the set S_{B} is reported to the higher layers, for example the MAC layer 604.

The example operation in flow diagram 800 begins at step 806 when it is determined that the number of resource candidates remaining in S_{A} after the resource exclusion step 804 is <0.2 Mₜₒₜₐₗ. The process then proceeds to step 816 where it is determined whether the transmission priority is HighTx. If it is determined that the priority is HighTx (for example, the priority of the transmission prio_{TX} is HighTx), the process proceeds to step 818 to check whether a counter value is less than the ThTimesLowResouceForLowTx If it is determined that the counter value is less than the ThTimesLowResouceForLowTx, the process proceeds to step 814 where the Th_{a,b} is increased by 3 dB and the counter value is incremented by, for example, a value of 1. The process then proceeds back to step 804 for a repeated procedure of the resource exclusion process. If it is determined at step 818 that the counter value is not less than the ThTimesLowResouceForLowTx, the process proceeds to step 822 where all resource candidates are moved from S_{A} to S_{B}. The process then proceeds to step 812 where the S_{B} is reported to the higher layers.

On the other hand, if it is determined in step 816 that the priority is not HighTx, (for example, the transmission priority prio_{TX} is LowTx), the process proceeds to step 820 where it is determined whether a counter value is less than ThTimesHighAndLowResouceForHighTx. If so, the process proceeds to step 814 where the Th_{a,b} is increased by 3 dB and the counter value is incremented by, for example, a value of 1. The process then proceeds back to step 804 for a repeated procedure of the resource exclusion process. If it is determined in step 820 that the counter value is not less than ThTimesHighAndLowResouceForHighTx, the process then proceeds to step 822 to move all resource candidates from S_{A} to S_{B}. The process then proceeds to step 812 where the S_{B} is reported to the higher layers.

For the 8 priority levels (0-7, 3 bits as in LTE) of prio_{TX}, they can be categorized into two groups by pre-configuration or by higher level signaling, for example, HighTx (for priority 0-3) and LowTx (for priority 4-7) as mentioned above. Advantageously, less complexity is achieved if priorities are categorized into groups, hence allowing lower power consumption. It will be appreciated that the plurality of priority levels may also be categorized into a plurality of priority groups.

In various embodiments, the above flow process increases the parameter (Th_{a,b} in this case) by at most a pre-configured number of iterations for the exclusion process from a set S_{A}. The pre-configured number of iterations is based on an at least one of the plurality of priority levels. The plurality of resources remaining in the set S_{A} after the exclusion process are then moved to a set S_{B} after the parameter is increased by the pre-configured number of iterations. The set SB is then reported to the higher layer.

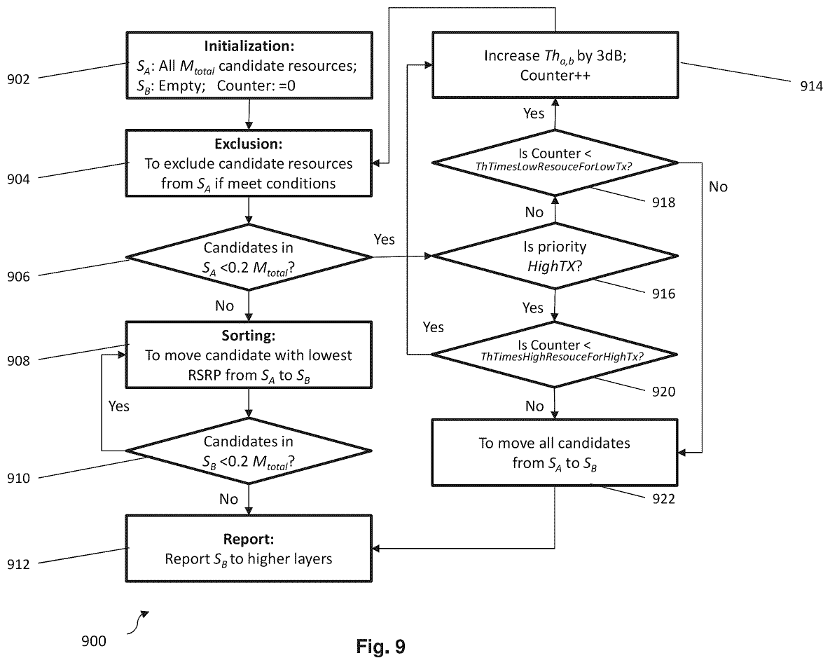

In various embodiments, a ThTimesHighResourceForHighTx (instead of ThTimesHighAndLowResouceForHighTx as shown in step 820 in the flow diagram 800 of FIG. 8) may be (pre-)configured as a maximum number where Th_{a,b} can be increased for the resource indicated by HighTx for the transmission with a priority level of HighTx. FIG. 9 shows a flow diagram 900 that illustrates the same process as that of flow diagram 800, except that in step 906 (corresponding to step 806 of flow diagram 800), the ThTimesHighResourceForHighTx instead of ThTimesHighAndLowResouceForHighTx is used. For example, In the flow diagram 900 as in FIG. 9, if remaining candidate resources in set S_{A} is less than the candidate resource ratio (e.g., 20% as in LTE) in the 1^{st} iteration at step 906:
if prio_{TX} is LowTx,
   Th_{a,b} of the resource indicated by LowTx is increased up to ThTimesLowResourceForLowTx until 20%*Mₜₒₜₐₗ remaining resource candidates are satisfied in set S_{A}
   if not, the resource is reported to the upper layer in set S_{B}
if prio_{TX} is HighTx,
   Th_{a,b} of the resource indicated by HighTx is increased up to ThTimesHighResourceForHighTx until 20% Mₜₒₜₐₗ remaining candidate resources are satisfied in set S_{A}
   if not, the resource is reported to the upper layer in set S_{B}

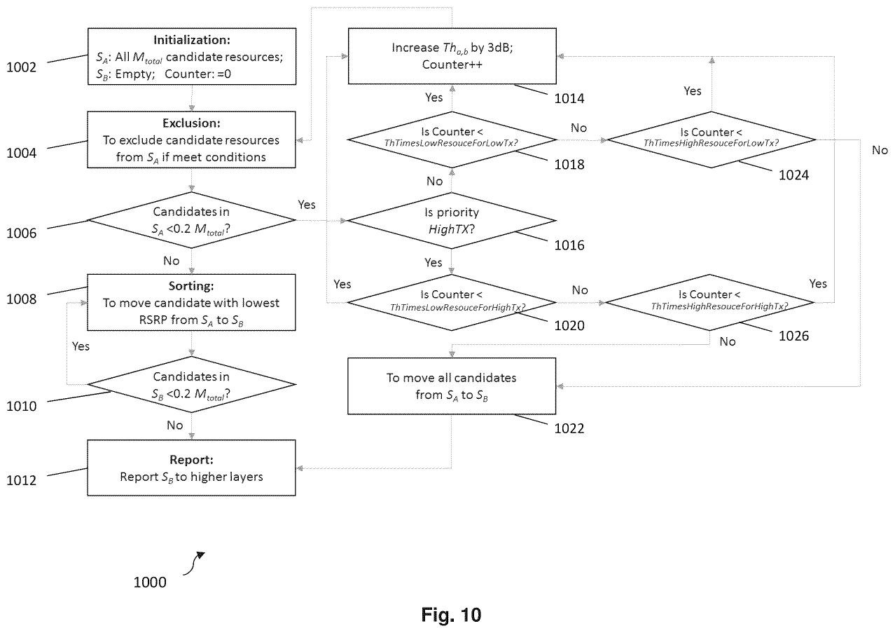

In various embodiments, the process as shown in flow diagram 800 may be further expanded to include additional iterations from step 818 and/or step 820 of flow diagram 800. Flow diagram 1000 of FIG. 10 illustrates the same process as shown in flow diagram 800 with the inclusion of such additional processes at step 1018 (corresponding to step 818 of flow diagram 800) and step 1020 (corresponding to step 820 of flow diagram 800). For example, a ThTimesHighResourceForLowTx may be (pre-)configured as a maximum number (can be a value of zero) where Th_{a,b} can be increased for resource(s) indicated by HighTx for a transmission with a priority level of LowTx, and a ThTimesLowResourceForHighTx may be (pre-)configured as a maximum number where Th_{a,b} can be increased for resource(s) indicated by LowTx for a transmission with a priority level of HighTx. The ThTimesHighResourceForLowTx and ThTimesLowResourceForHighTx are utilised in steps 1024 and 1026 of flow diagram 1000 respectively. In various embodiments, the additional processes are as follows:
In the flowchart 1000 as shown in FIG. 10, if it is determined that the remaining candidate resources in set S_{A} is less than the candidate resource ratio (e.g., 20% as in LTE) in the 1^{st} iteration in step 1006:
   if prio_{TX} is LowTx,
      Th_{a,b} of the resource indicated by LowTx is increased up to ThTimesLowResourceForLowTx until 20%*Mₜₒₜₐₗ remaining candidate resources are satisfied in set S_{A}
   if not, Th_{a,b} of the resource indicated by HighTx is increased up to ThTimesHighResourceForLowTx until 20%*Mₜₒₜₐₗ remaining candidate resources are satisfied in set S_{A}
   if not, the resource is reported to the upper layer in set S_{B}.
if prio_{TX} is HighTx,
   Th_{a,b} of the resource indicated by LowTx is increased up to ThTimesLowResourceForHighTx until 20%*Mₜₒₜₐₗ remaining candidate resources are satisfied in set S_{A}
   If not, Th_{a,b} of the resource indicated by HighTx is increased up to ThTimesHighResourceForHighTx until 20%*Mₜₒₜₐₗ remaining candidate resources are satisfied in set S_{A}
   if not, the resource is reported to the upper layer in set S_{B}

In various embodiments, the above flow process increases the parameter (Th_{a,b} in this case) up to a first number of iterations for an exclusion process of the plurality of resource candidates from a set S_{A}, wherein the first number of iterations has a maximum number of iterations based on an at least one of the plurality of priority levels. It is then determined whether the plurality of resource candidates remaining in the set S_{A} after the first number of iterations is less than the candidate resource ratio. When it is determined that the plurality of resource candidates remaining in the set S_{A} after the first number of iterations is less than the candidate resource ratio, the parameter is further increased up to a second number of iterations for the exclusion process from the set S_{A}, wherein the second number of iterations has a maximum number of iterations based on the at least one of the plurality of priority levels. The plurality of resources remaining in the set S_{A} are then moved to a set S_{B} after the parameter is increased by the second number of iterations. The set S_{B} is then reported to the higher layer.

In various embodiments, instead of utilising the common threshold formular Th_{a,b}=8*a+b+1, by assigning prio_{TX} to be a and prio_{Rx} to be b, numerical threshold values can also be pre-configured and/or indicated by higher level signaling for different transmission priorities, such that the parameter Th_{a,b} is adjusted based on prio_{TX} and prio_{Rx}. For example, an initial threshold value(s), intermediate threshold value(s), upper boundary value(s), etc may be indicated. It will be appreciated that other parameters besides Th_{a,b} may also be adjusted by prio_{TX} and prio_{Rx} so as to achieve categorization using priority levels for resource selection.

In various embodiments, the increment of Th_{a,b} at each iteration of the exclusion process can also be pre-configured and/or indicated by higher level signaling to be not limited to 3 dB each time.

In various embodiments, different percentage limits for the Mₜₒₜₐₗ resource candidates can also be pre-configured and/or indicated by higher level signaling as restrictions for different transmission priorities, such as for example the percentage limit for HighTx may be 30%, and the percentage for LowTx may be 20% (or vice versa).

In various embodiments, different percentage segmentation for the Mₜₒₜₐₗ resource candidates can also be pre-configured and/or indicated by higher level signaling as restrictions for different transmission priorities. For example, for a common percentage limit of 20% for HighTx and LowTx, the segment of [0, 10%) may be designated for HighTx, and the segment of [10%, 20%] may be designated for LowTx (or vice versa).

In various embodiments, the prio_{TX} can be categorized into multiple groups and not limited to two, where the extreme case is that each priority level may be one group. The same operations as described in the flow diagrams of FIG. 8 to FIG. 10 would still apply for these multiple groups. It will be appreciated that a plurality of priority levels and/or priority groups are therefore possible for adjusting the concerned parameter.

In various embodiments, instead of categorization for prio_{Tx} only, the priority for received SCIs such as prio_{Rx} can also be utilised for the categorization of priority levels, such as for example HighRx and LowRx for prio_{Rx} 0-3 and 4-7 respectively.

In various embodiments, multiple sets of resources (S_{B}) may be reported to higher layers depending on the number of categories of priorities and/or SL-RSRP thresholds.

It will be appreciated that the parameter to be adjusted based on the priority level may not necessarily be the Th_{a,b}. For example, the percentage limit for the Mₜₒₜₐₗ resource candidates may be utilised as the adjustable parameter instead, wherein the percentage limit for HighTx may be 30%, and the percentage for LowTx may be 20% (or vice versa).

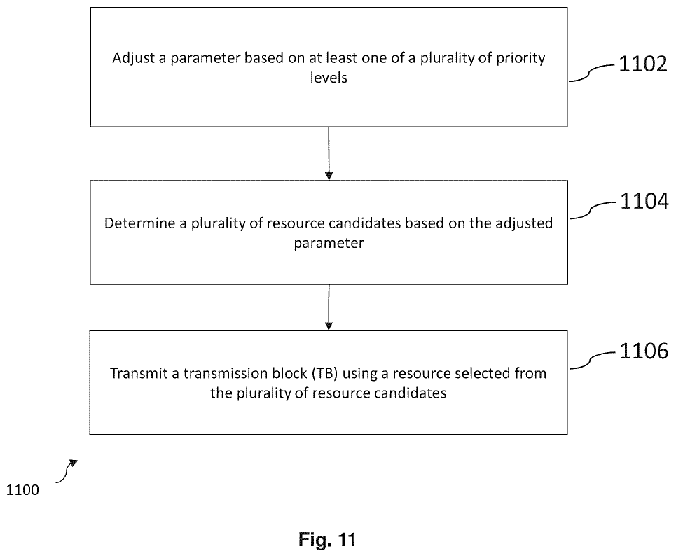

FIG. 11 shows a flow diagram 1100 illustrating a communication method according to various embodiments. In step 1102, a parameter is adjusted based on at least one of a plurality of priority levels. In step 1104, a plurality of resource candidates are determined based on the adjusted parameter. In step 1106, a TB is transmitted using a resource selected from the plurality of resource candidates.

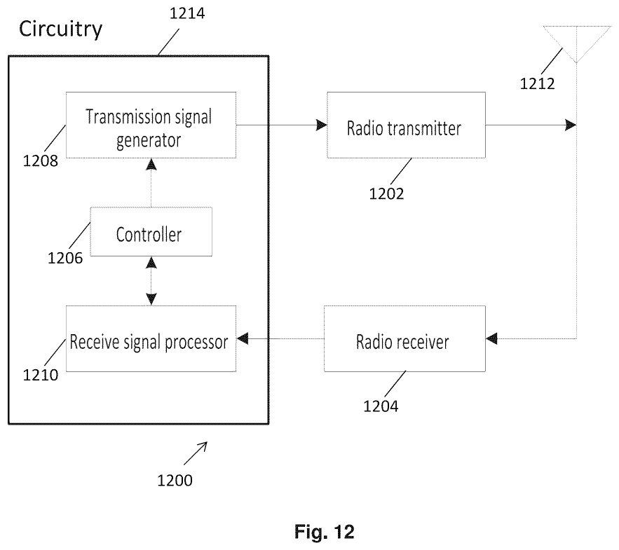

FIG. 12 shows a schematic, partially sectioned view of the communication apparatus 1200 that can be implemented for establishing the V2X communications in accordance with various embodiments as shown in FIGS. 1 to 11. The communication apparatus 1200 may be implemented as a U E according to various embodiments.

Various functions and operations of the communication apparatus 1200 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 12, the communication apparatus 1200 may include circuitry 1214, at least one radio transmitter 1202, at least one radio receiver 1204, and at least one antenna 1212 (for the sake of simplicity, only one antenna is depicted in FIG. 12 for illustration purposes). The circuitry 1214 may include at least one controller 1206 for use in software and hardware aided execution of tasks that the at least one controller 1206 is designed to perform, including control of communications with one or more other communication apparatuses in a wireless network. The circuitry 1214 may furthermore include at least one transmission signal generator 1208 and at least one receive signal processor 1210. The at least one controller 1206 may control the at least one transmission signal generator 1208 for generating signals (for example, a signal containing release information relating to a reserved resource) to be sent through the at least one radio transmitter 1202 to one or more other communication apparatuses and the at least one receive signal processor 1210 for processing signals (for example, a signal containing release information relating to a reserved resource) received through the at least one radio receiver 1204 from the one or more other communication apparatuses under the control of the at least one controller 1206. The at least one transmission signal generator 1208 and the at least one receive signal processor 1210 may be stand-alone modules of the communication apparatus 1200 that communicate with the at least one controller 1206 for the above-mentioned functions, as shown in FIG. 12. Alternatively, the at least one transmission signal generator 1208 and the at least one receive signal processor 1210 may be included in the at least one controller 1206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1202, at least one radio receiver 1204, and at least one antenna 1212 may be controlled by the at least one controller 1206.

The communication apparatus 1200, when in operation, provides functions required for utilization of SL-RSRP in V2X resource sensing & selection. For example, the communication apparatus 1200 may be a UE, and the circuitry 1214 may, in operation, adjust a parameter based on at least one of a plurality of priority levels, and determine a plurality of resource candidates based on the adjusted parameter. The transmitter 1202 may, in operation, transmit a transmission block (TB) using a resource selected from the plurality of resource candidates.

The circuitry 1214 may be further configured to adjust the parameter to a maximum value relating to the at least one of the plurality of priority levels, wherein the maximum value may be indicated by a pre-configuration or a higher layer signaling.

The circuitry 1214 may be further configured to adjust the parameter to a first maximum value relating to a first priority level or a second maximum value relating to a second priority level, wherein the first and second maximum values may be indicated by a pre-configuration or a higher layer signaling.

The circuitry 1214 may be further configured to increase the parameter by a (pre-)configured value up to a maximum value of the parameter when the plurality of resource candidates meets a condition, wherein the (pre-)configured value is indicated by a pre-configuration or a higher layer signaling.

The pre-configured value may be different among the plurality of priority levels. The at least one of the plurality of priority levels may comprise a priority level of the TB. The at least one of the plurality of priority levels may be indicated by a control Information.

The plurality of priority levels may be categorised into one or more priority groups, such that each of the one or more priority groups may comprise one or more priority levels, wherein the circuitry 1214 may be further configured to adjust the parameter up to a maximum value relating to a priority group which the at least one of the plurality of priority levels is categorised. The maximum value relating to each of the one or more priority groups may be different among the priority groups.

The circuitry 1214 may be further configured to increase the parameter of the plurality of resource candidates by at most a pre-configured number of iterations for an exclusion process from a set S_{A}, the pre-configured number of iterations based on the at least one of the plurality of priority levels; move the plurality of resources remaining in the set S_{A} after the exclusion process to a set S_{B} after the parameter is increased by the pre-configured number of iterations; and report the set S_{B} to the higher layer.

The circuitry 1214 may be further configured to increase the parameter up to a first number of iterations for an exclusion process of the plurality of resource candidates from a set S_{A}, the first number of iterations having a maximum number of iterations based on the at least one priority level; determine whether the plurality of resource candidates remaining in the set S_{A} after the first number of iterations is less than a candidate resource ratio; further increase the parameter up to a second number of iterations for the exclusion process from the set S_{A} when it is determined that the plurality of resource candidates remaining in the set S_{A} after the first number of iterations is less than the candidate resource ratio, the second number of iterations having a maximum number of iterations based on the at least one priority level; move the plurality of resources remaining in the set S_{A} to a set S_{B} after the parameter is increased by the second number of iterations; and report the set S_{B} to a higher layer.

The candidate resource ratio may be configured to be a percentage value different from 20%. The parameter may comprise a Th_{a,b}. The circuitry 1214 may be further configured to increase the Th_{a,b} in each iteration of an exclusion process by a value different from 3 dB.

As described above, the embodiments of the present disclosure provide an advanced communication system, communication methods and communication apparatuses for utilization of SL-RSRP in V2X resource sensing & selection that advantageously prevents transmissions with low priority from impeding transmissions with high priority.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. An integrated circuit comprising:
determination circuitry which, in operation, controls determining a parameter relating to a number of resource candidates based on at least one of a plurality of priority levels, determining a first plurality of resource candidates based on a threshold of Reference Signal Received Power (RSRP), and determining a second plurality of resource candidates from among the first plurality of resource candidates based on the parameter; and
a transmission circuitry which, in operation, controls transmitting a transmission block (TB) using a resource selected from the second plurality of resource candidates.

2. The integrated circuit according to claim 1, wherein the parameter is determined to be a first value relating to a first priority level or a second value relating to a second priority level, wherein the first and second values are indicated by a higher layer signaling.

3. The integrated circuit according to claim 1, wherein the at least one of the plurality of priority levels comprises a priority level of the TB.

4. The integrated circuit according to claim 1, wherein the at least one of the plurality of priority levels is indicated by a control information.

5. The integrated circuit according to claim 1, wherein the determination circuitry, in operation:
increases the parameter up to a first number of iterations for an exclusion process of the second plurality of resource candidates from a set S_{A}, the first number of iterations having a maximum number of iterations based on the at least one of the plurality of priority levels;
determines whether the second plurality of resource candidates remaining in the set S_{A} after the first number of iterations is less than a candidate resource ratio;
further increases the parameter up to a second number of iterations for the exclusion process from the set S_{A} when it is determined that the second plurality of resource candidates remaining in the set S_{A} after the first number of iterations is less than the candidate resource ratio, the second number of iterations having a maximum number of iterations based on the at least one of the plurality of priority levels;
moves the plurality of resources remaining in the set S_{A} to a set S_{B} after the parameter is increased by the second number of iterations; and
reports the set S_{B} to a higher layer.

6. The integrated circuit according to claim 1, wherein the parameter is configured to be a percentage value different from 20%.

7. A process controlled by an integrated circuit, the process comprising:
determining a parameter relating to a number of resource candidates based on at least one of a plurality of priority levels, determining a first plurality of resource candidates based on a threshold of Reference Signal Received Power (RSRP), and determining a second plurality of resource candidates from among the first plurality of resource candidates based on the parameter; and
transmitting a transmission block (TB) using a resource selected from the second plurality of resource candidates.

8. The process according to claim 7, wherein the parameter is determined to be a first value relating to a first priority level or a second value relating to a second priority level, wherein the first and second values are indicated by a higher layer signaling.

9. The process according to claim 7, wherein the at least one of the plurality of priority levels comprises a priority level of the TB.

10. The process according to claim 7, wherein the at least one of the plurality of priority levels is indicated by a control information.

11. The process according to claim 7, comprising:
increasing the parameter up to a first number of iterations for an exclusion process of the second plurality of resource candidates from a set SA, the first number of iterations having a maximum number of iterations based on the at least one of the plurality of priority levels;
determining whether the second plurality of resource candidates remaining in the set S_{A} after the first number of iterations is less than a candidate resource ratio;
further increasing the parameter up to a second number of iterations for the exclusion process from the set S_{A} when it is determined that the second plurality of resource candidates remaining in the set S_{A} after the first number of iterations is less than the candidate resource ratio, the second number of iterations having a maximum number of iterations based on the at least one of the plurality of priority levels;
moving the plurality of resources remaining in the set S_{A} to a set S_{B} after the parameter is increased by the second number of iterations; and
reporting the set S_{B} to a higher layer.

12. The process according to claim 7, wherein the parameter is configured to be a percentage value different from 20%.

13. A non-transitory computer-readable medium having contents which cause processing circuitry to perform a method, the method comprising:
determining a parameter relating to a number of resource candidates based on at least one of a plurality of priority levels, determining a first plurality of resource candidates based on a threshold of Reference Signal Received Power (RSRP), and determining a second plurality of resource candidates from among the first plurality of resource candidates based on the parameter; and
transmitting a transmission block (TB) using a resource selected from the second plurality of resource candidates.

14. The non-transitory computer-readable medium according to claim 13, wherein the parameter is determined to be a first value relating to a first priority level or a second value relating to a second priority level, wherein the first and second values are indicated by a higher layer signaling.

15. The non-transitory computer-readable medium according to claim 13, wherein the at least one of the plurality of priority levels comprises a priority level of the TB.

16. The non-transitory computer-readable medium according to claim 13, wherein the at least one of the plurality of priority levels is indicated by a control information.

17. The non-transitory computer-readable medium according to claim 13, wherein the method comprises:
increasing the parameter up to a first number of iterations for an exclusion process of the second plurality of resource candidates from a set SA, the first number of iterations having a maximum number of iterations based on the at least one of the plurality of priority levels;
determining whether the second plurality of resource candidates remaining in the set S_{A} after the first number of iterations is less than a candidate resource ratio;
further increasing the parameter up to a second number of iterations for the exclusion process from the set S_{A} when it is determined that the second plurality of resource candidates remaining in the set S_{A} after the first number of iterations is less than the candidate resource ratio, the second number of iterations having a maximum number of iterations based on the at least one of the plurality of priority levels;
moving the plurality of resources remaining in the set S_{A} to a set S_{B} after the parameter is increased by the second number of iterations; and
reporting the set S_{B} to a higher layer.

18. The non-transitory computer-readable medium according to claim 13, wherein the parameter is configured to be a percentage value different from 20%.
